(19) United States
(12) Patent Application Publication
(10) Pub. No.: US 2026/0298379 A1
(43) Pub. Date: Oct. 1, 2026

(54) WELL PIPE HAVING ELECTRICAL CONDUCTOR WITH IMPROVED ELECTRICAL CONTACTS

(71) Applicant: Reelwell AS, Sola (NO)

(72) Inventors: Morten Olav Meling, Stavanger (NO); Marius Hornes, Stavanger (NO); Espen Alhaug, Stavanger (NO)

(21) Appl. No.: 19/539,241

(22) Filed: Feb. 13, 2026

Related U.S. Application Data
(63) Continuation of application No. PCT/IB2024/056869, filed on Jul. 15, 2024.
(60) Provisional application No. 63/533,097, filed on Aug. 16, 2023.

(51) Int. Cl. F16L 25/01; E21B 17/00; E21B 17/02; E21B 17/042; F16L 15/00; F16L 25/02

(52) U.S. Cl. CPC F16L 25/01; E21B 17/003; E21B 17/028; E21B 17/042; F16L 15/002; F16L 25/021; F16L 25/025

(57) ABSTRACT

A well pipe having an electrical conductor includes at least one pipe segment having a bore or channel extending along a length of the pipe segment between a first threaded connection at one end and a second threaded connection at another longitudinal end. At least one insulated electrical conductor extends along the bore or channel. A receiving feature is disposed in each of the first threaded connection and the second threaded connection for receiving an electrical contact assembly. The electrical contact assembly comprises an insulator having a retaining feature for disposing at least one electrical contact therein. The at least one electrical contact is electrically connected to the at least one insulated electrical conductor, wherein at least part of the at least one electrical contact is exposed from the retaining feature.

### CROSS REFERENCE TO RELATED APPLICATIONS

Continuation of International Application PCT/IB2024/056869 filed on Jul. 15, 2024. Priority is claimed from US Provisional Application No. 63/533,097 filed on Jul. 16, 2023. Both applications are incorporated herein by reference in their entireties.

### STATEMENT REGARDING FEDERALLY SPONSORED RESEARCH OR DEVELOPMENT

Not Applicable.

### Names of the Parties to a Joint Research Agreement

Not Applicable.

### BACKGROUND

This disclosure relates, though not exclusively, to the field of construction of subsurface wells. More particularly, the disclosure relates to structures for pipe used to complete such wells, wherein the pipe has one or more insulated electrical conductors used as an electrical power and/or signal channel.

Canadian U.S. Pat. Nos. 3,002,675 and 11,236,551 describe a structure for and a method for making well drilling pipe (drill pipe) having an insulated electrical conductor that may be used as a channel for electrical power and signal communication between the surface and one or more electrically powered tools in a well while the well is being drilled. In general, the pipe described in the foregoing publications uses industry standard sections (joints) of drill pipe. Each joint of pipe has inserted therein an electrical insulation layer on an interior surface of the pipe joint, and has an electrical conductor structure radially expanded against the insulation layer and bonded to the insulation layer. The electrical conductor structure is made so that it can be radially expanded, longitudinally contracts as a result of being radially expanded, and undergoes no plastic deformation by reason of the radial expansion.

The pipe structure disclosed in the foregoing publications is particularly adapted for conditions during well drilling, in particular, bending and cyclic torsional stresses applied to the assembled joints of pipe (the pipe “string”) while moving in a wellbore, repeated axial loading and unloading, and repeatedly making and breaking threaded connections between joints or “stands” (joints assembled into sections of two, three or four joints) as the well drilling progresses. It is contemplated that such drill pipe will be removed from service due to metal fatigue or the threaded connections at the longitudinal ends of each pipe joint becoming unserviceable as the pipe joints have such threaded connections repeatedly recut. Recut of threaded pipe connections is used to keep drill pipe in service after the threaded connections become damaged during use and handling.

More recently, there is interest in using a so-called “wired” pipe to provide electrical power and signal communication channels for wells on which drilling is finished, and the wells require installation of a casing or liner to protect exposed formations and to seal the well from fluid movement between rock formations at different depths. Such casing or liner is known to be placed in the well after drilling is finished, and such casing or liner is typically held in place in the wellbore by cement. The casing or liner may then be completed, for example, by perforating within rock formations expected to produce fluids such as oil and gas. Corresponding conditions may apply to wells in which one or more hydraulic or pneumatic control lines may be used, such as to operate inflow control devices or safety valves.

It may be reasonably expected that casing or liner may be exposed to flowing fluid for an extended period of time, and in some cases at elevated temperatures depending on the depth from which the fluids enter the well. As a result, a casing or liner having an electrical conductor made as described in the foregoing publications for drill pipe may not be best suited for such conditions. The pipe structure disclosed in the foregoing patent publications is not suitable for use with hydraulic and/or pneumatic control lines. The foregoing issues may be equally understood to be relevant to smaller diameter pipe, called tubing, ordinarily nested within a casing or liner in a well. Collectively, such pipe may be referred to as well completion pipe, well construction pipe, well pipe or wellbore tubular(s); the foregoing terms may be used interchangeably in this disclosure.

International Application Publication No. WO/2022/224149 describes a structure for well pipe having an axial channel in which may be enclosed one or more electrical conductors, or one or more hydraulic lines. In the case of electrical conductors, in order to extend the electrical conductors along the entire axial length of the assembled segments of pipe, it is necessary to provide electrical contacts proximate each axial end of each pipe segment, so that when the pipe segments are assembled end to end the electrical contacts in adjacent pipe segments are urged into contact with each other to make electrical connection. The disclosed electrical contacts may be improved.

Accordingly, there is a need for a well pipe having one or more insulated electrical conductors that have improved electrical connection between assembled adjacent pipe segments.

### SUMMARY

One aspect of the present disclosure is a well pipe having at least one insulated electrical conductor. A well pipe according to this aspect includes at least one pipe segment having a bore or channel extending along a length of the pipe segment between a first threaded connection at one end and a second threaded connection at another longitudinal end. At least one insulated electrical conductor extends along the bore or channel. A receiving feature is disposed in each of the first threaded connection and the second threaded connection for receiving an electrical contact assembly. The electrical contact assembly comprises an insulator having a retaining feature for disposing at least one electrical contact therein. The at least one electrical contact is electrically connected to the at least one insulated electrical conductor, wherein at least part of the at least one electrical contact is exposed from the retaining feature.

In some implementations, at least one of, a face angle of the insulator is oblique, a radius of curvature defined by the electrical contact in the first threaded connection is different from a radius of curvature defined by the electrical contact in the second threaded connection or the retaining feature defines a round cross section groove traversing more than 180 degrees of circumference around the electrical contact disposed therein.

In some implementations, the insulator comprises a longitudinal extension protruding from one side of a face of the insulator.

In some implementations the longitudinal extension comprises a taper.

In some implementations, the first threaded connection and the second threaded connection each comprises a male threaded connection.

Some implementations further comprise at least one pipe connector having a female threaded connection at each longitudinal end. Each female threaded connection of the at least one pipe connector comprises a receiving feature for receiving an electrical contact assembly. The electrical contact assembly in each female threaded connection comprises an insulator having a retaining feature for disposing at least one electrical contact therein. The at least one electrical contact is electrically connected to at least one insulated electrical conductor disposed in a bore extending between the female threaded connection at each longitudinal end. In one or both female connectors, at least part of the at least one electrical contact is exposed from the retaining feature.

In some implementations, in the at least one pipe connector at least one of, (i) a face angle of the insulator is oblique, (ii) a radius of curvature defined by the electrical contact in the threaded connections is different from a radius of curvature defined by the electrical contact in at least one threaded connection in the pipe segment, or (iii) the retaining feature defines a round cross section groove traversing more than 180 degrees of circumference around the electrical contact disposed therein.

In some implementations, the retaining feature for receiving an electrical contact assembly in the at least one pipe connector cooperates with the receiving feature for receiving an electrical contact assembly in either the first threaded connection or the second threaded connection in the at least one pipe segment to form a pressure isolated chamber, wherein the electrical contact assembly in the female threaded connection and the electrical contact assembly in the first threaded connection or the second threaded connection of the at least one segment of pipe are disposed in the chamber when the first threaded connection or the second threaded connection is assembled to the female threaded connection.

In some implementations, the receiving feature for receiving an electrical contact assembly in the female threaded connection comprises an expansion space for the insulator.

In some implementations, the at least one pipe connector comprises a casing collar.

In some implementations the receiving feature disposed in each of the first threaded connection and the second threaded connection comprises an expansion space for the insulator.

In some implementations assembly of the first threaded connection to a corresponding threaded connection on an adjacent pipe segment or pipe connector defines a chamber isolated from fluid pressure outside the well pipe and from within an interior of the pipe by creating a metal-to-metal seal.

In some implementations, the insulator comprises an elastomer.

In some implementations, the electrical contact is retained in the retaining feature by adhesive.

Other aspects and possible advantages will be apparent from the following description and claims.

### BRIEF DESCRIPTION OF THE DRAWINGS

FIG. 1 shows a cross-section of assembled segments (joints) of an example implementation of a well pipe according to the present disclosure.

FIG. 2 shows an enlarged view of insulated electrical contacts in adjacent pipe segments of the implementation shown in FIG. 1.

FIG. 3 shows another enlarged view as in FIG. 2 to illustrate an example implementation of electrical insulators.

FIG. 3A shows an enlarged view as in FIG. 3 with a different shape for the electrical insulators having a longer electrical leakage path.

FIG. 4 shows an enlarged view of one of the electrical insulators of FIG. 3.

FIG. 4A shows an enlarged view of one of the electrical insulators of FIG. 3A

FIG. 5 shows an example implementation of electrical contacts in adjacent pipe segments placed into contact with each other.

FIG. 6 shows an oblique view of a female or box end of a pipe segment illustrating placement of the electrical contact and insulator.

FIG. 7 shows an oblique view of a two-conductor electrical contact and insulator.

FIG. 8 shows a view of the two-conductor contact with the insulator deemphasized.

FIG. 9 shows a view of the electrical contact and associated electrical conductors of FIG. 6 and FIG. 7.

FIG. 10 shows an example implementation of an electrical contact on a male or pin end of a pipe segment.

FIGS. 11, 12 and 13 show views corresponding to FIGS. 7, 8 and 9 but for the electrical contact shown in FIG. 10 and having only one electrical conductor.

FIG. 14 shows a side, cut away view of an electrical conductor and contact at one end of a pipe segment wherein the electrical conductor has bending stiffness reducing features.

FIG. 15 shows an enlarged view of the example electrical conductor of FIG. 14 to better illustrate bending stiffness reducing features.

FIG. 16 shows a side cut away view of another example implementation of an electrical conductor having an axial strain relief.

FIG. 17 shows an enlarged view of the electrical conductor of FIG. 16 to better illustrate the axial strain relief feature.

FIG. 18 shows an example implementation of a pipe segment and electrical contact according to the present disclosure having a plurality of insulated electrical conductors and associated electrical contacts usable, for example, in multiple phase electrical power transmission.

FIG. 19 shows an oblique view of the pin end segment shown in side oblique view in FIG. 18.

FIG. 20 shows an end view of the box end segment of FIG. 18 shown in obliques side view in FIG. 18.

### DETAILED DESCRIPTION

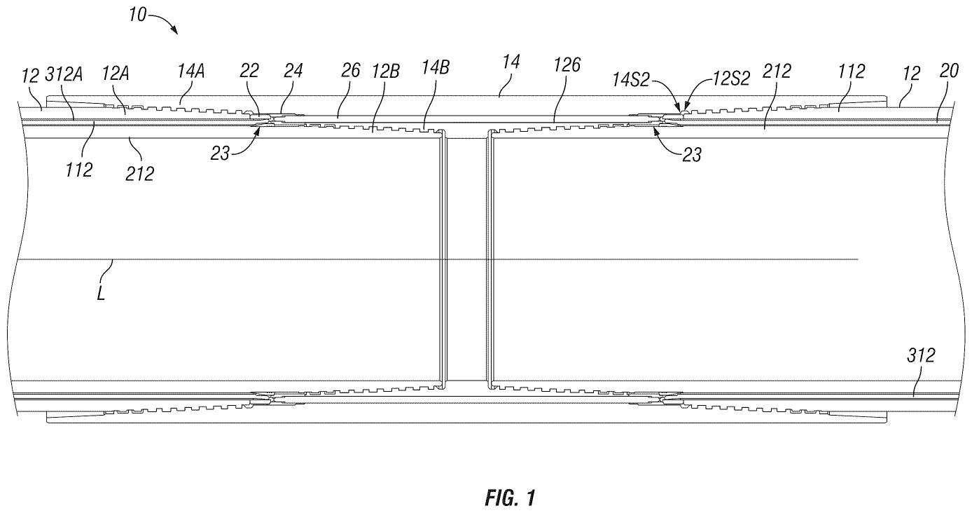

FIG. 1 shows an example implementation of assembled well pipe segments (joints) 10 according to the present disclosure. The individual pipe segments, shown at 12, may comprise pipe structures known in the art to be used, for example, in well construction, well completion and well intervention wherein each axial end of each pipe segment 12 comprises a male threaded end, or “pin” end. The pin end of each of the pipe segments 12 may be threadedly assembled into one female, or “box” end of a double female ended pipe connector referred to as a casing collar 14. Casing collars may be referred to as “double box” segments, in that some implementations have a box connector at each longitudinal end.

Although the present example implementation is described in terms of pipe segments having a pin connection on each axial end, wherein pipe segments are connected to each other by a collar or other double-female-ended connector, it is to be clearly understood that pipe segments having a pin at one axial end and a box at the other axial end are equally within the scope of the present disclosure, as are so-called “double box” pipe segments having a female threaded connection at both longitudinal ends. Accordingly, in the following description, structures described with reference to male thread connectors will be similar any of the foregoing possible pipe implementations; correspondingly, structures described with reference to female thread connectors will be similar in any of the foregoing pipe implementations.

In the example implementation shown in FIG. 1, each pipe segment 12 may comprise an outer pipe 112, within which may be nested an intermediate layer 312. An inner pipe 212 may be nested within the intermediate layer 312. The intermediate layer 312 may comprise, form or have formed therein a bore or channel 312A extending along the length of the intermediate layer 312. Some non-limiting example implementations of structures for the outer pipe 112, the intermediate layer 312 and the inner pipe 212 may be as described in International Application Publication No. WO 2022/224149 A1 assigned to the assignee of the present disclosure. It is to be understood, however, that the structures described in the foregoing publication are meant only as examples of possible pipe structures applicable to the present disclosure and are in no way intended to limit the scope of present disclosure. The channel or bore 312A may enclose one or more insulated electrical conductors 20. Axial ends of the one or more insulated electrical conductors 20 may be formed into or connected to a first electrical contact assembly 22. In the present example implementation, each longitudinal end of each pipe segment 12 may comprise such a first electrical contact assembly 22. The casing collar (sometimes, “collar’) 14 in the present example implementation may comprise, at corresponding places on each longitudinal end, a second electrical contact assembly 24. Each second electrical contact assembly 24 is placed into physical contact with the one of the first electrical contact assemblies 22 disposed on the corresponding pin end of the adjacent pipe segment 12 when the casing collar 14 is assembled to a pipe segment 12. One or more insulated electrical conductors 26 may extend axially along the casing collar 14 in a corresponding longitudinal bore 126 itself extending along the casing collar 14.

In the present example implementation, the inner pipe 212 may extend longitudinally beyond a longitudinal end of the outer pipe 112, such that the inner pipe 212 may have formed on its exterior surface and thereby define an inner threaded connection 12B. The outer pipe 112 may likewise have formed thereon and thereby define an outer threaded connection 12A. “Inner” and “outer” are used to mean a radial position with respect to a longitudinal axis L of the pipe segment 12. Such threaded connections 12A, 12B may mate with corresponding outer and inner threaded connections 14A, 14B formed on the interior surface of the casing collar 14. The corresponding threaded connections may, when assembled, form metal to metal seals, e.g., by having suitable inner and outer, axially spaced apart shoulders, such that a pressure isolated chamber 23 is defined between the adjacent assembled pin and box connections. It will be appreciated that “pressure sealed” in this context means with respect to fluid entry from outside the assembled pipe segments and from within the interior of the inner pipe 212. The bore or channel 312A could provide a fluid path longitudinally along the pipe segments 12 until a pipe string is fully assembled. In the present example implementation, the arrangement of the inner pipe 212, the outer pipe 112 and associated threaded connections 12B, 12A, and the mating threaded connections in the casing collar 14 cause the pressure isolated chamber 23 to be disposed (axially) longitudinally between or intermediate the inner threaded connection 12B and the outer threaded connection 12A. It is to be understood that for purposes of defining the scope of the present disclosure, however, that it is only necessary to provide a pressure isolated chamber at any longitudinal position along the threaded connections, such that assembling the pipe segments and/or collars end to end define such pressure isolated chambers.

It is to be further understood that the illustrated implementation in FIG. 1, wherein the channel or bore 312A is disposed in the intermediate layer 312, is only meant to serve as an example of how to implement an insulated electrical conductor extending along the length of a pipe segment. It is equally possible, for example, to make a pipe segment 12 from a single tube, forming threads which when assembled to an adjacent device (e.g., pipe segment or casing collar) define the described pressure isolated chamber; furthermore, the bore or channel 312A may be formed by longitudinal drilling through the wall of such single tube, extending between the pressure isolated chamber-defining features at each longitudinal end of the single tube. As previously explained, it is also within the scope of the present disclosure for each of or any portion of a plurality of the pipe segments to comprise a pin connection at one longitudinal end, such as shown in FIG. 1 and a box connection at the other longitudinal end, or a box connection at each longitudinal end. In such implementations, the components shown on one longitudinal side of the casing collar 14 would be correspondingly formed into the one or more, or the other longitudinal ends of all of the respective pipe segments.

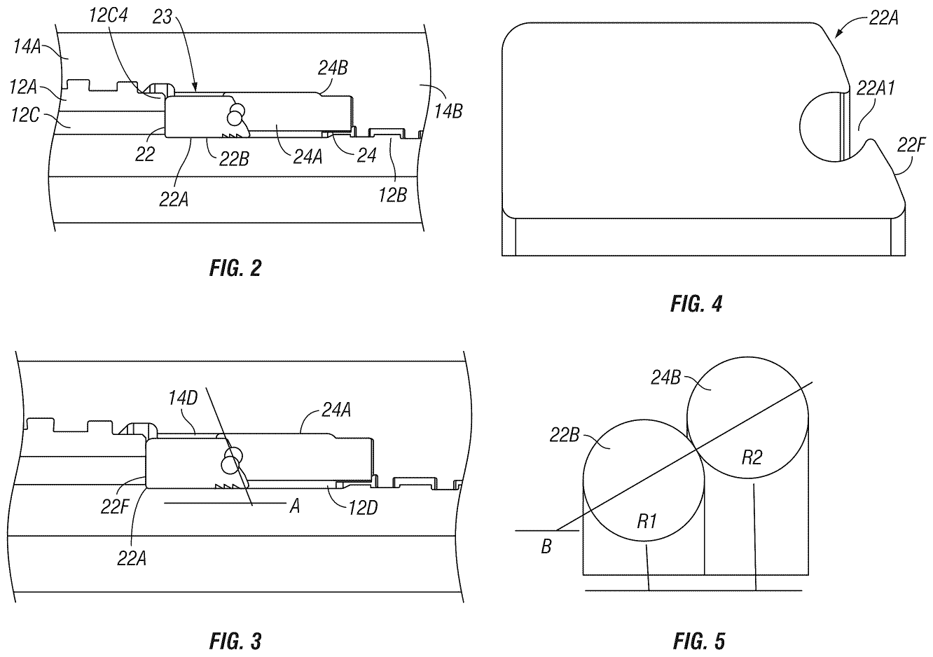

FIG. 2 shows an enlarged view of the pipe segment (12 in FIG. 1) assembled to the casing collar (14 in FIG. 1) to show the first and second electrical contact assemblies 22, 24 in more detail. The first electrical contact assembly 22 may be disposed at the longitudinal end of the channel or bore (312 in FIG. 1), and is shown at 12C in FIG. 2. In some implementations, and as shown in FIG. 2, the axial or longitudinal space between the inner threads 12B and outer threads 12A may be formed to provide a stop or shoulder 12C4 to limit longitudinal movement of an electrical insulator 22A (hereinafter “insulator” for convenience), which may be made from elastomer or other resilient, electrically insulating material. The stop or shoulder 12C4 may be referred to as a “receiving feature” because its function is ultimately to receive and hold the electrical contact assembly. The first electrical contact assembly 22 may comprise the insulator 22A, disposed as stated disposed on the shoulder 12C4 at the longitudinal end of the channel or bore 12C. An electrical contact 22B may be disposed in a retaining feature, e.g., a groove (explained in more detail with reference to FIG. 4) such that the electrical contact 22B is at least partially exposed (and may partially protrude beyond a surface of the insulator 22A) proximate the open longitudinal end of the retaining feature in the insulator 22A. The second electrical contact assembly 24 may be disposed at a longitudinal end of a corresponding part or receiving feature in the casing collar (14 in FIG. 1). The second electrical contact 24 may comprise an insulator 24A, such as may be made from elastomer or other resilient insulating material as is the insulator 22A in the first electrical contact assembly 22, and an electrical contact 24B disposed in a corresponding retaining feature in the r insulator 24A. When the pin end is threadedly assembled to the box end, as shown in FIG. 2, the first electrical contact assembly 22 is urged into contact with the second electrical contact assembly 24, whereby the corresponding electrical contacts 22B, 24B touch each other and may be provided, by the elastomer properties of the respective insulators 22A, 24A, with an axial biasing force to make good electrical connection between the respective contacts 22B, 24B. It will be appreciated that the threaded connection and electrical conductor/contact assembly/contact structures as described with reference to the casing collar 14 may be used in implementations of a well pipe that comprise a box connection on either or both longitudinal ends.

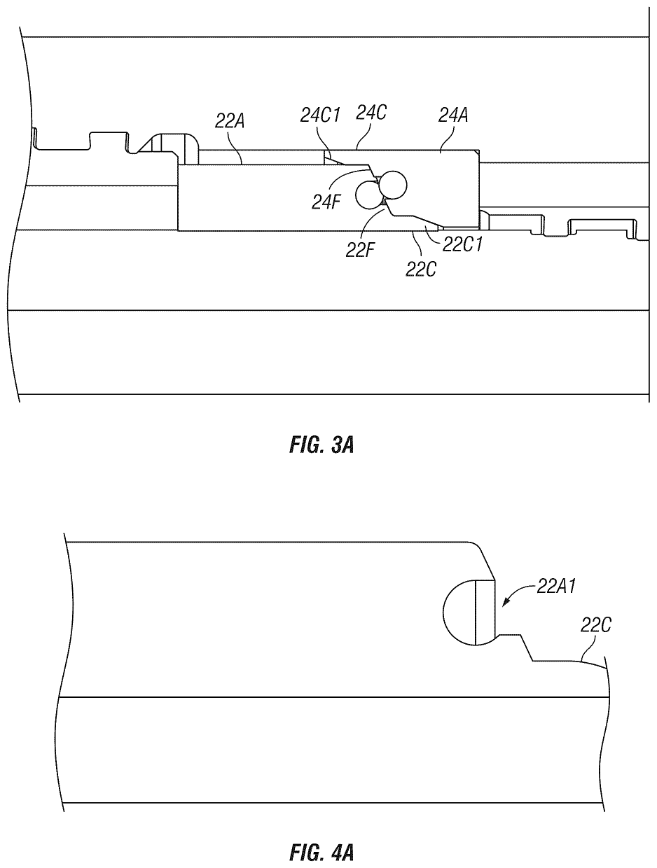

In the example implementation shown in FIG. 2, and with reference now to FIG. 3, the casing collar (14 in FIG. 1) and the pin end of the pipe (12 in FIG. 1) may have corresponding features, shown at 14D, 12D formed in the outer walls of the pressure isolated chamber features in order to provide space for the corresponding insulator 22A, 24A to expand radially when the insulators 22A, 24A are urged into contact with each other (and thereby are longitudinally compressed) during assembly of the corresponding pipe segments, in the present example, the pipe segment being assembled to the collar. In some implementations, and as shown in FIG. 3, the longitudinal end face of each of the insulators 22A, 24A may define an angle A, which may be an oblique angle, with reference to the longitudinal axis of the pipe segments. Such angle A may provide a device to facilitate draining any liquid that may have accumulated onto the longitudinal end face of either or both r insulators 22A, 24A. Such drainage may be into the respective expansion spaces 14D, 12D prior to threaded assembly of the pipe segments by reason of the sloping surface defined by such angle formed into the elastomer insulator faces.

As shown in FIG. 4, each insulator, e.g., 22A, may comprise a retaining feature 22A1 in its “mating” face 22F, into which the corresponding electrical contact, e.g., 22B in FIG. 3) may be disposed. The mating face 22F will be urged into contact with the corresponding insulator (e.g., 24A in FIG. 3) when the pipe segments are assembled. A cross-section of the electrical contact (e.g., 22B in FIG. 2) may have shape, as may have the retaining feature, e.g., 22A1 such that the insulator material tends to retain the electrical contact within the retaining feature 22A1 and thereby in the body of the insulator 22A. As non-limiting examples, the electrical contact 22B may have a circular cross-section (see, e.g., FIG. 5) and the retaining feature 22A1 may form a circular cross-section channel traversing more than 180 degrees but less than 360 degrees of circumference. In this way, at least part of the electrical contact 22B will be exposed and be able to come into galvanic contact with the adjacent electrical contact (e.g., 24B in FIG. 5) while being strongly retained inside the retaining feature 22A1. During assembly, the electrical contact (e.g., 22B, 24B in FIG. 5) may be pressed into the retaining feature 22A1 such that elastic displacement of the insulating material will enable the electrical contact to move fully into the retaining feature 22A1, and then the insulating material (e.g., elastomer) can return approximately to its unstressed shape. Such return to the unstressed state will tend to retain the electrical contact 22B inside the retaining feature 22A1. It will be appreciated that the retaining feature may traverse less than 180 degrees, and in some embodiments, the electrical contact 22B may be retained in the retaining feature, for example, by adhesive.

Some implementations of the insulators 22A, 24A, and referring to FIG. 3A, may comprise a longitudinal extension 22C, 24C, respectively from the respective face 22F, 24F. When the insulators 22A, 24A are urged into longitudinal contact, the longitudinal extension on one insulator 22C, 24C engages the exterior surface of the opposed insulator, 24A, 22A, respectively. Such longitudinal extensions 22C, 24C provide increased length of surfaces of the insulator 22A, 24A in contact with the opposed insulator, 24A, 22A, respectively, such that a length of an electrical leakage path along the juncture between the insulators 22A, 24A is increased. Thus, electrical insulation of the assembled pipe segments may be improved with respect to the insulators shown in FIG. 2, FIG. 3 and FIG. 4 notwithstanding small amounts, e.g., as a film, of electrically conductive substance on the insulators 22A, 24A. Such substance may be, without limitation, brackish or salty water. The longitudinal extensions 22C, 24C, may include a respective taper 22C1, 24C1 to facilitate engagement of the insulators 22A, 24A with each other when the pipe segments are assembled.

In some implementations, and referring to FIG. 5, the first electrical contact 22B may define a first radius of curvature R1 and the second electrical contact 24B may define a second radius of curvature R2 different than the first radius of curvature R1, for example larger. In this way, when the first electrical contact 22B is urged axially into contact with the second electrical contact 24B, a defined contact angle B between the diameters of the electrical contacts is oblique with respect to the longitudinal axis of the pipe segments. Such oblique angle B may provide increased contact force between the electrical contacts 22B, 24B by reason of both axial and radial components of force applied between the two electrical contacts 22B, 24B, thereby improving electrical conductivity therebetween. In some implementations, one or both electrical contacts 22B, 24B may be made from resilient spring metal such as phosphor bronze, to provide additional contact force therebetween as explained above.

FIGS. 6 through 9 show various views of another example implementation of an electrical contact assembly according to the present disclosure, having more than one electrical contact and more than one insulated electrical conductor. The illustrated electrical contact assembly can be electrically connected to a corresponding electrical contact assembly disposed in an adjacent connected pipe segment or collar. The implementation shown in FIG. 6 represents one of the second electrical contact assemblies 24, which in the present disclosure is disposed in or proximate the box end connection (e.g., 14), however corresponding structural devices may be provided for the first electrical contact assembly (e.g., 22 in FIG. 2) to be urged into contact by assembling adjacent pipe segments, or pipe to collar, as explained elsewhere herein. The second electrical contact assembly 24 may comprise an insulator 24A, e.g., elastomer or other resilient electrically insulating material, formed as explained elsewhere herein, so as to have a retaining feature such as a groove (see 22A1 in FIG. 4) in which may be disposed electrical contacts, to be explained further below.

FIG. 7 shows the second electrical contact assembly 24 apart from the pipe segment (14 in FIG. 6). The insulator 24A may comprise on a face opposed to the retaining feature 24A1 (e.g., a groove) one or more indexing tabs 24A2. The one or more indexing tabs 24A2 may protrude from the opposed face so as to extend into corresponding receptacles (not shown) formed in the pipe segment, or may simply provide additional friction to reduce the possibility of the insulator 24A being rotated when the adjacent pipe segments are threadedly connected. In the present example implementation, there may be more than one insulated electrical conductors. A first electrical conductor 20A, may extend through a corresponding channel or bore along the pipe segment (see, e.g., FIG. 1). The first electrical conductor 20A may terminate within the insulator 24A in a first electrical contact segment 20A1. The segment 20A1 may be in the form of a partial circumferential segment disposed in a part of the circumference of the retaining feature 24A1. A second electrical conductor 20B may extend through a corresponding channel or bore along the pipe segment, similar to that for the first electrical conductor 20A, and may terminate in a second electrical contact segment 20B1, disposed in a different circumferential segment of the retaining feature 24A. It will be appreciated that the first 20A1 and the second 20B1 contact segments may comprise any or all of the foregoing devices, as may the insulator 24A, as explained with reference to FIGS. 2 through 5. It will be further appreciated that a corresponding structure of two electrical contact segments may be provided on the adjacent electrical contact, so that electrical connection may be made between two (or more) individual insulated electrical conductors. The illustrated fraction of the circumference traversed by each of the first and second electrical contact segments 20A1, 20B1 is only to illustrate the principle of the electrical contact segments. It will be appreciated that the fraction of circumference traversed may be more limited in order to provide some amount of rotational indexing tolerance, whereby exact rotational alignment when starting and assembling threaded connections on adjacent pipe segments is not required in order for the respective electrical contacts to electrically engage each other correctly between the adjacent pipe segments.

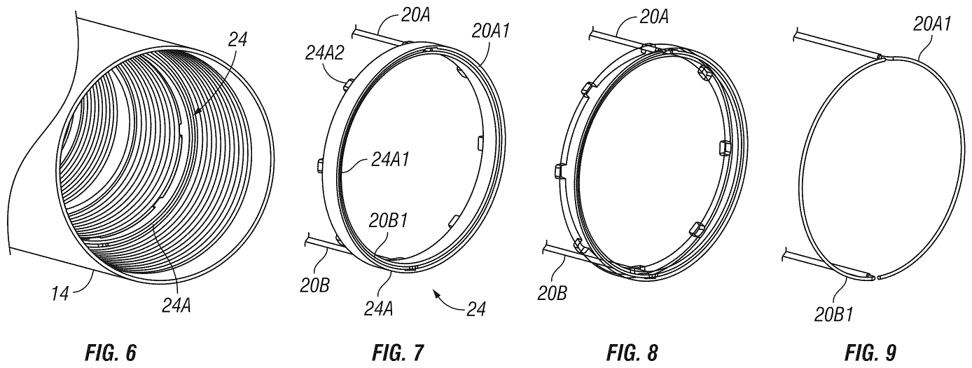

FIG. 8 shows a view of the electrical conductors and corresponding electrical contact segments, wherein the elastomer insulator is deemphasized. FIG. 9 shows the example implementation of the first electrical conductor 20A and the second electrical conductor 20B.

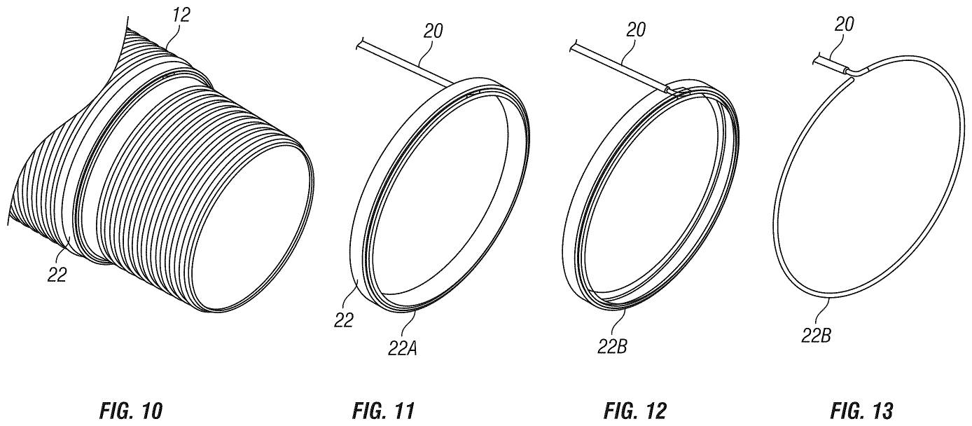

Views corresponding to those shown in FIGS. 6 through 9 are shown in FIGS. 10 through 13, respectively, for a single electrical conductor implementation of the electrical connector. Such implementation may comprise the first electrical contact assembly 22 as explained with reference to FIG. 2 disposed in the pin end of a pipe segment 12. FIG. 10 shows the first electrical contact assembly 22 disposed on the pin end of the pipe segment 12. FIG. 11 shows the first electrical contact assembly 22 apart from the pipe segment 12, wherein may be observed the insulator 22A and the electrical conductor 20. FIG. 12 shows the first electrical contact assembly 22 with the insulator 22A deemphasized to highlight the electrical contact 22B and the electrical conductor 20. FIG. 13 shows only the electrical conductor 20 and the contact 22B.

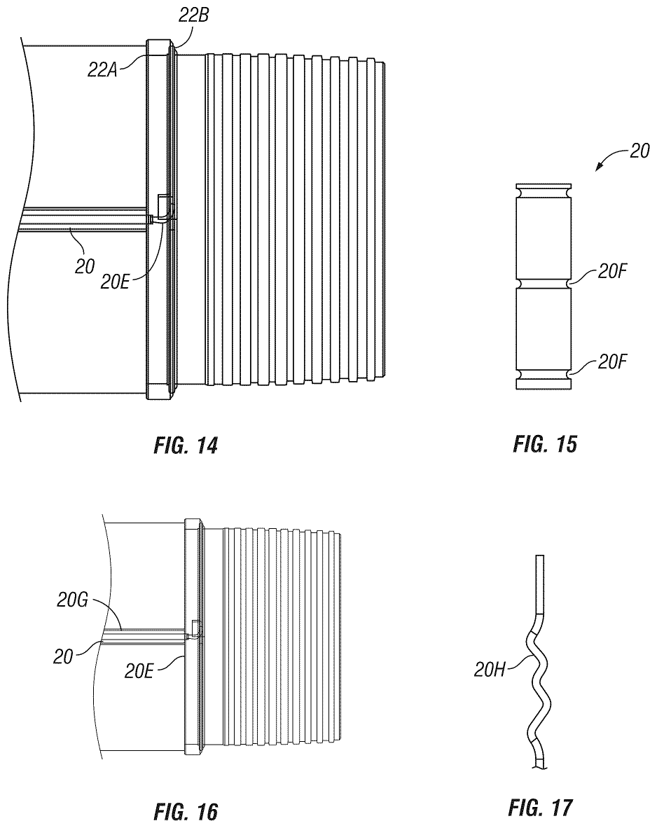

FIGS. 14 and 15 show an example implementation of one of the electrical conductors 20 and the associated electrical contacts 22B. The combination of the electrical conductor 20 and the electrical contact 22B may be formed from a single length of electrical conductor having insulator removed over a predetermined length from the end of the conductor, wherein a transition from the electrical conductor 20 to the electrical contact 22B is provided by a bend 20E at a place where the electrical conductor 20 passes through the insulator 22A. To facilitate shaping the electrical conductor 20 as shown in FIG. 14, the electrical conductor 20 may comprise one or more bend stiffness reducing features. FIG. 15 shows an example implementation of such bend stiffness reducing features, wherein the electrical conductor 20 may comprise one or more grooves 20F in its exterior surface.

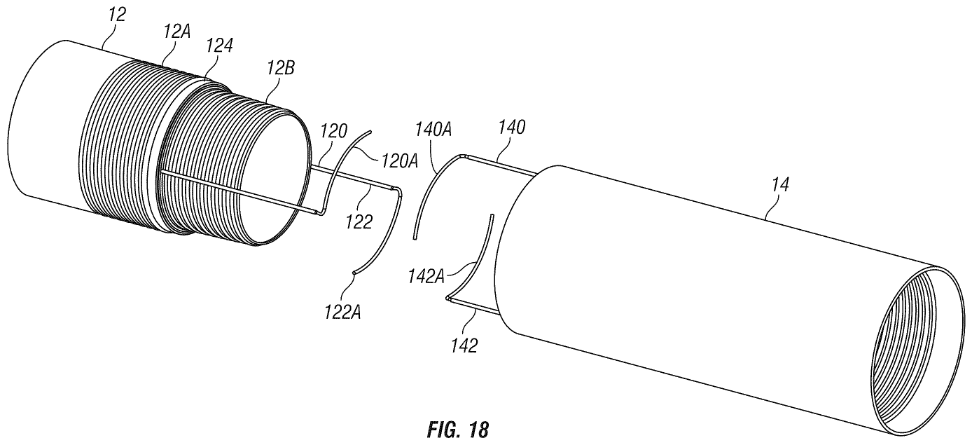

In FIG. 16, an end 20G of the electrical conductor 20 proximate the bend 20E may comprise an axial strain relief to provide the electrical conductor 20 with the capability of being axially elongated without being axially deformed. FIG. 17 shows an example of such strain relief 20H in the form of bends or coils. By providing such strain relief 20H, an assembled pipe according to the present disclosure may reduce the possibility of damage to the electrical conductor 20 when the assembled pipe undergoes substantial axial elongation or compression during use. As will be appreciated by those skilled in the art, such axial elongation increases in a direction of the surface end of the assembled well pipe as it is extended into a well to great depth, by reason of the suspended weight of the assembled well pipe.

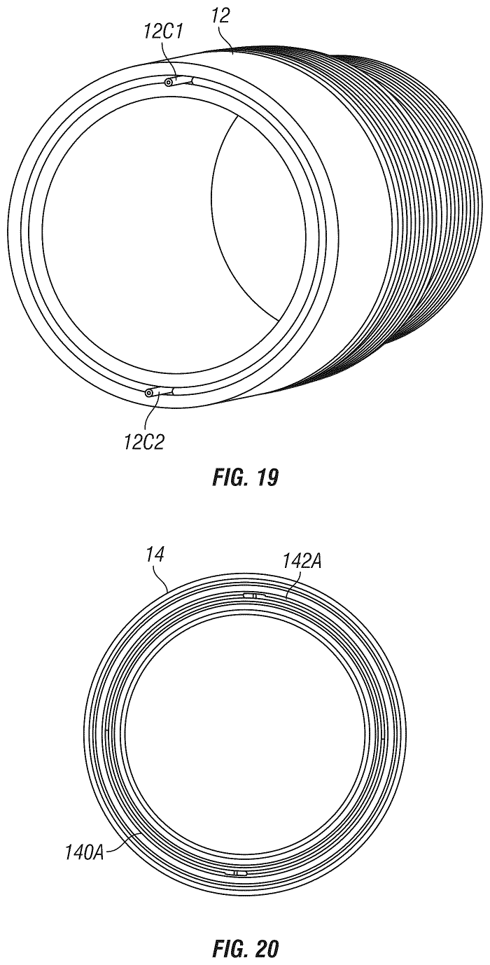

FIG. 18 shows a partially exploded view of an example implementation of a pipe segment and electrical contact assembly according to the present disclosure having a plurality of insulated electrical conductors and associated electrical contacts usable, for example, in multiple phase electrical power transmission. A pin end of a pipe segment 12, which may be structured as explained earlier with reference to FIG. 1, may comprise inner threads 12B and outer threads 12A, also as explained with reference to FIG. 1. A first electrical contact assembly may comprise an elastomer insulator disposed in a receiving feature located intermediate the inner threads 12B and outer threads 12A. A first electrical conductor 120 and a second electrical conductor 122 may extend each within a bore (see 12C1 and 12C2 in FIG. 19) along the length of the pipe segment 12, and may terminate in a respective electrical contact 120A, 122A. The respective electrical contacts 120A, 122A may traverse only a part of, i.e., a circumferential segment of the circumference of the elastomer insulator 122A. The two electrical contacts 120A, 122A are shown separated by an angle of about 180 degrees and have a circumferential extent of about 90 degrees, however the angular separation and circumferential extent are not limitations on the scope of the present disclosure. In some implementations, the circumferential extent and angular separation may be optimized to balance contact area and to reduce the need for specific rotational orientation of the respective pipe segment threads during assembly (“make up”) of the pipe segments to each other. The example angular separations described above are not limitations on the scope of the present disclosure. Corresponding electrical conductors 140, 142 may be provided to a double female threaded connector, e.g., a casing collar 14, structured as explained with reference to FIG. 1, but having more than one through bore (26 in FIG. 1) each of which may be occupied by one of the corresponding electrical conductors 140, 142. Each electrical conductor 140, 142 may terminate in a corresponding electrical contact 140A, 142A. The electrical contacts 120A, 122A on the pin end are urged into contact with the electrical contacts 140A, 142A on the collar 14. By suitably arranging the circumferential location of the respective electrical contacts and suitable choice of their circumferential extent, assembly of the pin end to the collar 14 may be facilitated, while making correct galvanic electrical contact only between corresponding pairs of electrical contacts, e.g., contact 120A mates with contact 140A, and contact 122A mates with contact 142A. Although the present example implementation is described with reference to two electrical conductors and associated electrical contacts, it will be appreciated that more or fewer electrical conductors and associated electrical contacts in any well pipe are within the scope of the present disclosure.

It will also be appreciated that the partially exploded view in FIG. 18 shows the electrical conductors 120, 122, 140, 142 and the respective electrical contacts 120A, 122A, 140A, 142A out of their assembled positions on the pipe segment 12 and the collar 14 for purposes of illustrating in particular the electrical contacts. The ordinary positions of the electrical conductors 120, 122, 140, 142 and the respective electrical contacts 120A, 122A, 140A, 142A is similar to what is shown in and explained with reference to FIG. 1.

FIG. 19 shows an oblique view of the pin end segment shown in side oblique view in FIG. 18, and in particular shows possible locations of the two through bores or channels 12C1, 12C2.

FIG. 20 shows an end view of the box end segment of FIG. 18 shown in oblique side view in FIG. 18. The circumferential separation of the two contacts 140A and 142A are particularly illustrated in FIG. 20.

A wired well pipe according to the present disclosure may provide better electrical conductivity and reduced risk of insulation failure with respect to wired well pipe known in the art prior to the present disclosure.

In light of the principles and example implementations described and illustrated herein, it will be recognized that the example implementations can be modified in arrangement and detail without departing from such principles. The foregoing discussion has focused on specific implementations, but other configurations are also contemplated. In particular, even though expressions such as in “an implementation,” or the like are used herein, these phrases are meant to generally reference implementation possibilities, and are not intended to limit the disclosure to particular implementation configurations. As used herein, these terms may reference the same or different implementations that are combinable into other implementations. As a rule, any implementation referenced herein is freely combinable with any one or more of the other implementations referenced herein, and any number of features of different implementations are combinable with one another, unless indicated otherwise. Although only a few examples have been described in detail above, those skilled in the art will readily appreciate that many modifications are possible within the scope of the described examples. Accordingly, all such modifications are intended to be included within the scope of this disclosure as defined in the following claims.

What is claimed is:

1. A well pipe having an electrical conductor, comprising:
at least one pipe segment having a bore or channel extending along a length of the pipe segment between a first threaded connection at one longitudinal end of the at least one pipe segment and a second threaded connection at another longitudinal end of the at least one pipe segment, at least one insulated electrical conductor extending along the bore or channel; and
a receiving feature disposed in each of the first threaded connection and the second threaded connection for receiving an electrical contact assembly, the electrical contact assembly comprising an insulator having a retaining feature for disposing at least one electrical contact therein, the at least one electrical contact electrically connected to the at least one insulated electrical conductor, wherein at least part of the at least one electrical contact is exposed from the retaining feature; and
wherein at least one of, a face angle of the insulator is oblique with reference to a longitudinal axis of the at least one pipe segment, a radius of curvature defined by the electrical contact in the first threaded connection is different from a radius of curvature defined by the electrical contact in the second threaded connection or the retaining feature defines a round cross section groove traversing more than 180 degrees of circumference around the electrical contact disposed therein.

2. The well pipe of claim 1 wherein the insulator comprises a longitudinal extension protruding from one side of a face of the insulator.

3. The well pipe of claim 2 wherein the longitudinal extension comprises a taper.

4. The well pipe of claim 1 wherein the first threaded connection and the second threaded connection each comprises a male threaded connection.

5. The well pipe of claim 4 further comprising:
at least one pipe connector having a female threaded connection at each longitudinal end, each female threaded connection of the at least one pipe connector comprising a receiving feature for receiving an electrical contact assembly;
the electrical contact assembly in each female threaded connection comprising an insulator having a retaining feature for disposing at least one electrical contact therein, the at least one electrical contact electrically connected to at least one insulated electrical conductor disposed in a bore extending between the female threaded connection at each longitudinal end; and
wherein in one or both electrical contact assemblies, at least part of the at least one electrical contact is exposed from the retaining feature.

6. The well pipe of claim 5 wherein, in the at least one pipe connector at least one of, (i) a face angle of the insulator is oblique, (ii) a radius of curvature defined by the electrical contact in the threaded connections is different from a radius of curvature defined by the electrical contact in at least one threaded connection in the pipe segment, or (iii) the retaining feature defines a round cross section groove traversing more than 180 degrees of circumference around the electrical contact disposed therein.

7. The well pipe of claim 6 wherein the feature for receiving an electrical contact assembly in the at least one pipe connector cooperates with the receiving feature in either the first threaded connection or the second threaded connection in the at least one pipe segment to form a pressure isolated chamber, wherein the electrical contact assembly in the female threaded connection and the electrical contact assembly in the first threaded connection or the second threaded connection of the at least one segment of pipe are disposed in the chamber when the first threaded connection or the second threaded connection is assembled to the female threaded connection.

8. The well pipe of claim 6 wherein the feature for receiving an electrical contact in the female threaded connection comprises an expansion space for the insulator.

9. The well pipe of claim 6 wherein the at least one pipe connector comprises a casing collar.

10. The well pipe of claim 1 wherein the feature disposed in each of the first threaded connection and the second threaded connection for receiving an electrical contact comprises an expansion space for the insulator.

11. The well pipe of claim 1 wherein assembly of the first threaded connection to a corresponding threaded connection on an adjacent pipe segment or pipe connector defines a chamber isolated from fluid pressure outside the well pipe and from within an interior of the pipe by creating a metal-to-metal seal.

12. The well pipe of claim 1 wherein the insulator comprises an elastomer.

13. The well pipe of claim 1 wherein the electrical contact is retained in the retaining feature by adhesive.

14. A well pipe having an electrical conductor, comprising:
at least one pipe segment having a bore or channel extending along a length of the pipe segment between a first threaded connection at one longitudinal end of the at least one pipe segment and a second threaded connection at another longitudinal end of the at least one pipe segment, at least one insulated electrical conductor extending along the bore or channel;
a receiving feature disposed in each of the first threaded connection and the second threaded connection for receiving an electrical contact assembly, the electrical contact assembly comprising an insulator having a retaining feature for disposing at least one electrical contact therein, the at least one electrical contact electrically connected to the at least one insulated electrical conductor, wherein at least part of the at least one electrical contact is exposed from the retaining feature;
wherein the first threaded connection and the second threaded connection each comprises a male threaded connection;
at least one pipe connector having a female threaded connection at each longitudinal end, each female threaded connection of the at least one pipe connector comprising a receiving feature for receiving an electrical contact assembly;
the electrical contact assembly in each female threaded connection comprising an insulator having a retaining feature for disposing at least one electrical contact therein, the at least one electrical contact electrically connected to at least one insulated electrical conductor disposed in a bore extending between the female threaded connection at each longitudinal end; and
wherein in one or both electrical contact assemblies, at least part of the at least one electrical contact is exposed from the retaining feature.

15. The well pipe of claim 14 wherein at least one of, a face angle of the insulator is oblique, a radius of curvature defined by the electrical contact in the first threaded connection is different from a radius of curvature defined by the electrical contact in the second threaded connection or the retaining feature defines a round cross section groove traversing more than 180 degrees of circumference around the electrical contact disposed therein.

16. The well pipe of claim 15 wherein the insulator comprises a longitudinal extension protruding from one side of a face of the insulator.

17. The well pipe of claim 16 wherein the longitudinal extension comprises a taper.

18. The well pipe of claim 14 wherein the feature disposed in each of the first threaded connection and the second threaded connection for receiving an electrical contact comprises an expansion space for the insulator.

19. The well pipe of claim 14 wherein assembly of the first threaded connection to a corresponding threaded connection on an adjacent pipe segment or pipe connector defines a chamber isolated from fluid pressure outside the well pipe and from within an interior of the pipe by creating a metal-to-metal seal.

20. The well pipe of claim 14 wherein the insulator comprises an elastomer.

21. The well pipe of claim 14 wherein the electrical contact is retained in the retaining feature by adhesive.
